(19) United States
(12) Patent Application Publication
(10) Pub. No.: US 2007/0081925 A1
(43) Pub. Date: Apr. 12, 2007

(54) Exhaust gas system for an internal combustion engine

(76) Inventor: Markus Widenmeyer, Schoeneich (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/578,906

(22) PCT Filed: Nov. 2, 2004
(86) PCT No.: PCT/EP04/52748

§ 371 Date: May 12, 2006

(30) Foreign Application Priority Data
Nov. 15, 2003 (DE) 103 53 426.1

(51) Int. Cl. B01D 53/34

(52) U.S. Cl. 422/177

(57) ABSTRACT

An exhaust gas system for an internal combustion engine includes a depth filter for removing soot from the exhaust gas. The depth filter includes a catalyst material, which promotes the oxidation of soot. An internal pore structure of the depth filter is provided with a catalyst material, which is liquid beyond a temperature of approximately no higher than 400° C. and more preferably no higher than approximately 350° C.

### PRIOR ART

The invention relates to an exhaust gas system for an internal combustion engine, having a depth filter for removing soot from the exhaust gas; at least the depth filter includes a catalyst material which promotes the oxidation of soot.

An exhaust gas system of the type defined above is known from German Patent Disclosure DE 101 30 338 A1. In it, an exhaust gas system for a diesel engine is described. With the exhaust gas system, the intent is also to be able to filter soot particles out of the exhaust gas.

One possible way of doing this is surface filters, which are also realized as wall flow filters with a honeycomb structure, whose flow conduits are closed in alternation, so that the exhaust gas has to flow through the porous filter walls. To counteract clogging of the filter as the soot load increases, however, such a filter must be continuously or cyclically freed of the accumulating or already-accumulated soot. This can be done by means of thermal combustion and/or catalytic methods.

If thermal methods are employed, nitrogen monoxide from the exhaust gas must first be converted into nitrogen dioxide. That can in turn oxidize diesel soot beyond temperatures of approximately 300° C. However, since modern internal combustion engines emit only very little nitrogen monoxide, there is often not enough nitrogen dioxide available for converting the diesel soot. Catalytic methods, conversely, are so far often comparatively inefficient, since the areas of contact between the soot and the catalyst are small.

From DE 101 30 338 A1, a depth filter is also known. It has an open-pore system, which is designed such that even relatively large soot particles can be precipitated out inside the filter body. The filtering action of this depth filter therefore extends over its entire volume or its entire surface area. Once again, clogging of the depth filter is counteracted by providing it with a catalyst, which is intended to enable the oxidation of soot in the depth filter even at relatively low temperatures. To that end, catalyst particles are finely distributed over the surface of the depth filter.

The object of the present invention is to refine an exhaust gas system of the type defined at the outset such that on the one hand as high as possible a proportion of soot particles can be filtered out of the exhaust gas, and on the other hand, simple, effective regeneration of the filters used is possible.

This object is attained in an exhaust gas system of the type defined at the outset in that an internal pore structure of the depth filter is provided with a catalyst material which is liquid at an operating temperature of the depth filter, and in particular beyond a temperature of approximately no higher than 400° C., and highly preferably no higher than approximately 350° C.

### ADVANTAGES OF THE INVENTION

The use of a liquid catalyst in the depth filter employed has the advantage that the catalyst material can flow in the liquid state to the soot particles and can even cover them, and can oxidize accumulated soot at substantially lower temperatures than before. A multiple times larger area of contact between the soot particles and the catalyst material is created, which markedly increases the rate of oxidation of the soot particles deposited in the depth filter. The liquid state already exists at the operating temperature of the depth filter, which is normally associated with the exhaust gas temperature. The operating temperature can in turn be attained either in normal operation or in special phases of operation.

Advantageous refinements of the invention are recited in the dependent claims.

First, it is proposed that the catalyst material of the depth filter includes “molten salt” material, in particular Cs₂SO₄V₂O₅or Cs vanadates or Ag compounds, in particular Ag vanadates. These materials are in liquid form at temperatures beyond approximately 350° C.

These materials can optionally be combined with further catalytically acting substances, such as: Rh and/or Pd, on such substrates as aluminum, zirconium, cerium oxides and/or mixed oxides, such as Ce/ZrO₂, or without a substrate; elements of Group 11 (Ag, Au, and/or Cu) on such substrates as aluminum, zirconium, cerium oxides and/or mixed oxides, such as Ce/ZrO₂, or without a substrate; oxygen-storing and -releasing materials, such as compounds of Mn, Fe, Ce, and Pr; materials that form nitrate under exhaust gas conditions (NOₓ reservoir), in particular elements of the alkaline earth group, as well as of Group 3 and the rare earths; and/or materials which are distinguished by high acidity, such as zeolites and the following oxides or oxide mixtures: TiO₂, ZrO₂, SiO₂, Al₂O₃, and boric oxides.

An exhaust gas system in which the depth filter includes an open-pore silicon carbide foam filter with pore diameters in the range of approximately 40 μm to approximately 1000 μm and with a porosity of at least approximately 60% is especially advantageous. Such a depth filter can be produced comparatively inexpensively and simply and has a sufficiently good filtering capacity.

It is also proposed that the exhaust gas system includes a downstream surface filter; and that upstream of the surface filter is a catalytic converter, by which nitrogen dioxide is formed from the exhaust gas.

This exhaust gas system according to the invention makes it possible to filter out more than 99% of the soot particles contained in the exhaust gas. Although in principle a depth filter can filter out a maximum of only approximately 90% of the soot particles contained in the exhaust gas, this is made possible by the downstream surface filter, which in turn, from the approximately 10% soot component that passes through the depth filter, can filter out up to 95 to 99%. However, since overall only a slight quantity of soot even reaches the surface filter, this surface filter can be operated for a comparatively long time without having to be freed of the filter cake that forms there. Thus overall an exhaust gas system is created which functions simply, has a long service life, and makes it possible to filter out nearly the entire proportion of soot from the exhaust gas.

The catalytic converter proposed can in particular operate with a platinum catalyst material. As a result, in operation of the engine, nitrogen dioxide is formed, which burns off the soot at the surface filter at a suitable temperature. This is also possible continuously and makes it possible to keep the surface filter completely free of soot, since after all, from the depth filter only comparatively little soot even reaches the surface filter, so that only a comparatively slight quantity of soot has to be burned off there.

It is also possible that the exhaust gas system includes a downstream surface filter; and that a structure of the surface filter is provided with a catalyst material. Particles not trapped by the depth filter are filtered to at least a great extent out of the gas stream by the surface filter. Because of the upstream depth filter, however, the surface filter has to manage only some of the total particle mass, which makes its continuous regeneration, for instance by means of nitrogen oxides contained in the exhaust gas, possible. By means of the catalyst material, the oxidation of the soot particles at the surface filter is improved still further.

It is especially advantageous if the catalyst material of the surface filter includes a material from the extensive list above.

Alternatively or in addition, the catalyst material can also include a conventional NOₓ reservoir catalyst material, a conventional NH₃—SCR catalyst material, and/or some other material for reducing nitrogen oxide emissions. Thus the surface filter is given an additional function; that is, it also acts as a catalytic converter to reduce further emissions, particularly nitrogen oxide emissions.

A comparatively inexpensive surface filter is a cordierite filter having a cell number of from approximately 50 to approximately 300 cpsi, a porosity of approximately 50%, and a pore diameter no larger than approximately 100 μm, preferably no larger than approximately 40 μm, even more preferably no larger than approximately 10 μm.

The exhaust gas system of the invention is especially compact if the surface filter includes a Pt catalyst material, in particular Pt-CE/ZrO₂, on its inflow side and a conventional NOₓ, reservoir catalyst material on its outflow side. In that case, the nitrogen dioxide required for the soot combustion is generated at the entrance to the surface filter, and on the outflow side the surface filter acts as an NOₓ reservoir catalyst, which reduces the nitrogen oxide emissions.

The invention also pertains to a method for operating an internal combustion engine with an exhaust gas system of the type in which a surface filter is located downstream of the depth filter. It is proposed that soot depositing in the surface filter is oxidized continuously. This is possible since only comparatively few soot particles reach the surface filter, and because of the comparatively large volumetric flow that passes through the surface filter. In this way, the surface filter always remains maximally permeable, which is optimal for the efficiency of the exhaust gas system.

### DRAWING

An especially preferred exemplary embodiment of the present invention is described in further detail below in conjunction with the accompanying drawings. Shown in the drawings are:

FIG. 1, a schematic illustration of an exhaust gas system with a depth filter and downstream of it a surface filter;

FIG. 2, a schematic section through one region of the depth filter of FIG. 1;

FIG. 3, a detail III of FIG. 2; and

FIG. 4, a schematic section through one region of the surface filter of FIG. 1.

### DESCRIPTION OF THE EXEMPLARY EMBODIMENT

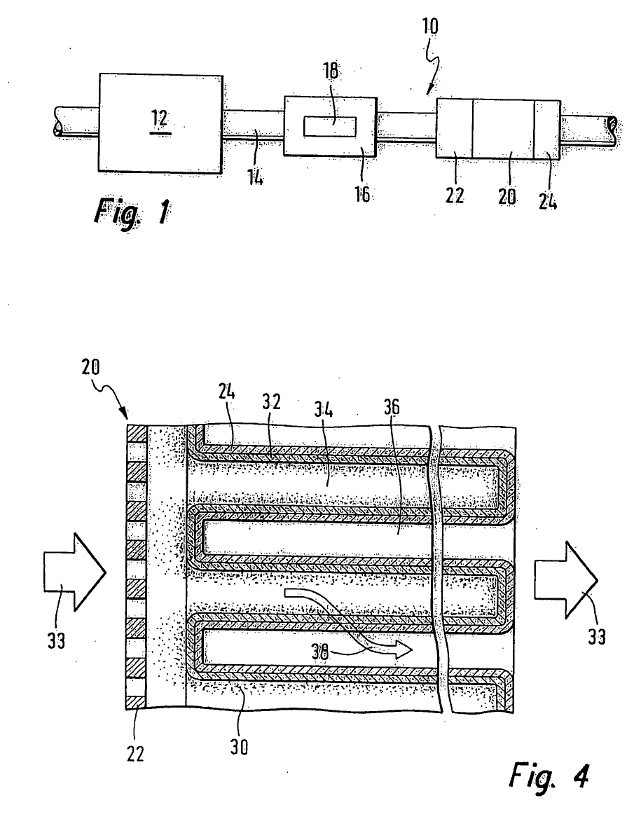

In FIG. 1, an exhaust gas system of an internal combustion engine is identified overall by reference numeral 10. The engine itself is shown only schematically and is identified by reference numeral 12. The hot combustion exhaust gases are carried away from the engine 12 via an exhaust pipe 14. This leads first to a depth filter 16, which is provided with a catalytic arrangement 18. This device will be described in greater detail hereinafter. From the depth filter 16, the exhaust pipe 14 leads onward to the surface filter 20. This surface filter is provided with a catalytic arrangement 22 on its inflow side and with a further catalytic arrangement 24 on its outflow side. It will likewise be described in greater detail hereinafter.

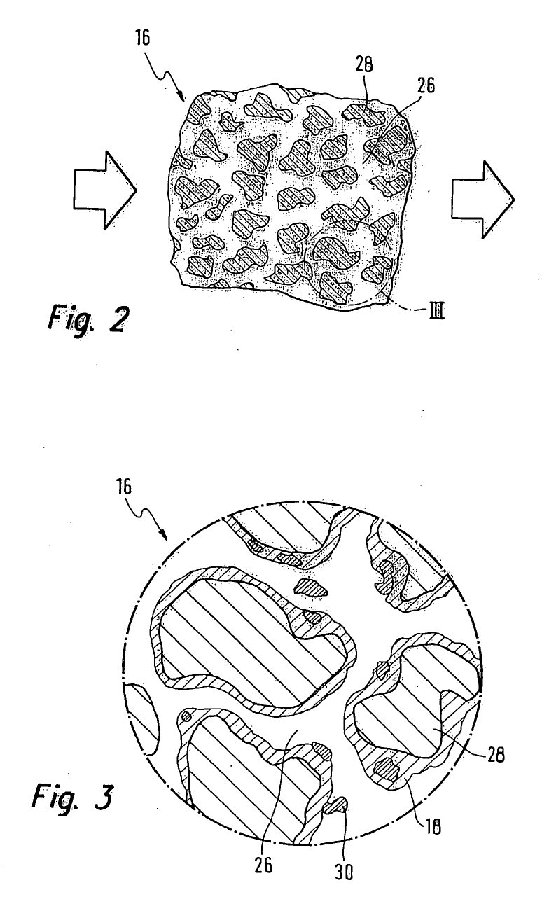

The engine 12 is a diesel engine. Its exhaust gas, especially during certain phases of operation, initially still contains soot particles, which are filtered out of the exhaust gas stream by the two filters 16 and 20. In the depth filter 16, the soot particles are deposited in the interior of the filter. In the depth filter 16, a filtering action thus exists over its total volume or its total surface area. One portion of an inner region of the depth filter 16 is shown in FIG. 2. As shown, the depth filter 16 has pores 26, which are formed between a structure 28 of the depth filter 16. In the present exemplary embodiment, this structure is produced from silicon carbide, so that a so-called open-pore silicon carbide foam filter 16 is formed.

For the depth filter 16, however, in principle all open-pore bodies and bulk materials comprising ceramic and metal material, and combinations of the two, that are suitable for filtering soot particles out of the exhaust gas that flows through the exhaust pipe 14 can be considered. In particular, it should be possible for even comparatively large soot particles to be filtered out by the depth filters. The pore diameter varies in the range from approximately 40 μm to approximately 1000 μm. Overall, the depth filter 16 has a porosity of more than 60%.

As seen in the enlarged detail in FIG. 3, the silicon carbide structure 28 of the depth filter 16 is provided with a catalyst material 18. The catalyst material is selected such that it promotes the oxidation or combustion of the soot particles (reference numeral 30 in FIG. 3) at comparatively low temperatures, thus preventing clogging of the depth filter 16. The catalyst material 18 that is used in the depth filter 16 has the special property that it is liquid at a comparatively low temperature. This temperature may be in the range of the normal operating temperature of the depth filter 16, so that during normal operation of the engine 12 the catalyst material 18 is always liquid; however, it may also be so high that the catalyst material 18 is liquid only whenever the engine 12 is in a special phase of operation, in which the exhaust gas output by the engine 12 through the exhaust pipe 14 has a correspondingly high temperature.

In so-called “molten salt” materials, such as Cs₂SO₄V₂O₅ or Cs vanadates, the temperature at which the catalyst material 18 is liquid is approximately 350 to 400° C. By the liquefaction of the catalyst material 18, the soot particles 30 precipitated out in a depth filter 16 are contacted very intimately by the catalyst material 18, and in part are even at least intermittently completely surrounded by it. As a result, a very high conversion rate is attained for the same energy input. Such liquid catalysts may also be combined with other catalytically active materials of the kind described at the outset.

In principle, the depth filter 16 shown has a filtering efficiency of a maximum of only 90%, however. This means that at least 10% of the soot particles 30 pass through the depth filter 16 and reach the surface filter 20. The surface filter 20 is a wall flow filter. It has a honeycomb structure, viewed in the flow direction, which is of cordierite and is identified by reference numeral 32 in FIG. 4. Some of the honeycombs are open on the side pointing toward the engine 12 and closed on the side facing away from the engine 12 (the exhaust gas stream is represented in FIG. 4 by arrows 33). These honeycombs are identified by reference numeral 34 in FIG. 4. Other honeycombs 36, adjacent to the honeycombs 34, are closed on the side toward the engine 12 and open on the side facing away from the engine 12.

The filtering action is due to the porosity of the structure 32 of the surface filter 20; that is, the exhaust gas stream passes through the wall faces from the honeycombs 34 into the honeycombs 36, as indicated by the arrow 38 in FIG. 4. The surface filter shown in FIG. 4 has a cell number of from 50 to 300 cpsi, a porosity of approximately 50%, and a pore diameter of from 10 to 30 μm. The porosity of the structure 32 is selected such that the surface filter 20 preferentially filters out small soot particles from the exhaust gas stream. The filtering efficiency of the surface filter 20 is in the range from 95 to 99%. In all, because of the combination of the depth filter 16 and the surface filter 20, thus over 90% of the soot particles are filtered out of the exhaust gas.

Over the course of time, the soot particles 30 deposited on the surface filter 20 form what is known as a “filter cake”, which, if it is too large, can impair the permeability of the surface filter 20 and thus can increase the exhaust gas counterpressure. However, this filter cake of soot particles 30 forms only very slowly, since overall, only very few soot particles 30 even reach the surface filter 20 in the first place. Nevertheless, the surface filter 20 is freed of the soot particles either continuously or cyclically by means of a so-called CRT process.

To that end, the surface filter 20, on its side toward the engine 12 (the inflow side), has a structure 22 with a platinum catalyst material, in this case a Pt—CE/ZrO₂ mixture. As a result, nitrogen monoxide contained in the exhaust gas anyway is oxidized to form nitrogen dioxide. By means of this nitrogen dioxide, the soot 30 deposited on the surface filter 20 can likewise be oxidized, preferably continuously, at comparatively low temperatures (below 400° C.).

The surface of the structure 32 of the surface filter 20 facing away from the engine 12 is provided with a catalyst layer 24, which in the present exemplary embodiment comprises a conventional NOₓ reservoir catalyst material. As a result, nitrogen oxides in the exhaust gas are reduced. This has nothing to do with the actual function of the surface filter 20, but it does economize on installation space. The use of other catalytically active materials, as listed at the outset, is fundamentally conceivable as well, however.

1-11. (canceled)

12. In a exhaust gas system for an internal combustion engine, having a depth filter for removing soot from the exhaust gas, the depth filter including a catalyst material which promotes the oxidation of soot, the improvement wherein an internal pore structure of the depth filter comprises with a catalyst material which is liquid at an operating temperature of the depth filter, and in particular beyond a temperature of approximately no higher than 400° C. and highly preferably no higher than approximately 350° C.

13. The exhaust gas system according to claim 12, wherein the catalyst material of the depth filter includes “molten salt” material, in particular Cs₂SO₄V₂O₅ or Cs vanadates or Ag compounds, in particular Ag vanadates.

14. The exhaust gas system according to claim 12, wherein the catalyst material additionally includes: Rh and/or Pd, on such substrates as aluminum, zirconium, cerium oxides and/or mixed oxides, such as Ce/ZrO₂, or without a substrate; elements of Group 11 (Ag, Au, and/or Cu) on such substrates as aluminum, zirconium, cerium oxides and/or mixed oxides, such as Ce/ZrO₂, or without a substrate; oxygen-storing and releasing materials, such as compounds of Mn, Fe, Ce, and Pr; materials that form nitrate under exhaust gas conditions (NOₓ reservoir), in particular elements of the alkaline earth group, as well as of Group 3 and the rare earths; and/or materials which are distinguished by high acidity, such as zeolites and the following oxides or oxide mixtures: TiO₂, ZrO₂, SiO₂, Al₂O₃, and boric oxides.

15. The exhaust gas system according to claim 12, wherein the depth filter includes an open-pore silicon carbide foam filter with pore diameters in the range of approximately 40 μm to approximately 1000 μm and with a porosity of at least approximately 60%.

16. The exhaust gas system according to claim 13, wherein the depth filter includes an open-pore silicon carbide foam filter with pore diameters in the range of approximately 40 μm to approximately 1000 μm and with a porosity of at least approximately 60%.

17. The exhaust gas system according to claim 14, wherein the depth filter includes an open-pore silicon carbide foam filter with pore diameters in the range of approximately 40 μm to approximately 1000 μm and with a porosity of at least approximately 60%.

18. The exhaust gas system according to claim 12, further comprising a downstream surface filter; and a catalytic converter, upstream of the surface filter by which catalytic converter nitrogen dioxide is formed from the exhaust gas.

19. The exhaust gas system according to claim 13, further comprising a downstream surface filter; and a catalytic converter, upstream of the surface filter by which catalytic converter nitrogen dioxide is formed from the exhaust gas.

20. The exhaust gas system according to claim 14, further comprising a downstream surface filter; and a catalytic converter, upstream of the surface filter by which catalytic converter nitrogen dioxide is formed from the exhaust gas.

21. The exhaust gas system according to claim 15, further comprising a downstream surface filter; and a catalytic converter, upstream of the surface filter by which catalytic converter nitrogen dioxide is formed from the exhaust gas.

22. The exhaust gas system according to claim 12, further comprising a downstream surface filter including a catalytic material on a structure of the surface filter.

23. The exhaust gas system according to claim 13, further comprising a downstream surface filter including a catalytic material on a structure of the surface filter.

24. The exhaust gas system according to claim 14, further comprising a downstream surface filter including a catalytic material on a structure of the surface filter.

25. The exhaust gas system according to claim 15, further comprising a downstream surface filter including a catalytic material on a structure of the surface filter.

26. The exhaust gas system according to claim 22, wherein the catalyst material includes “molten salt” material, in particular Cs₂SO₄V₂O₅ or Cs vanadates or Ag compounds, in particular Ag vanadates.

27. The exhaust gas system according to claim 22, wherein the catalyst material includes a conventional NOₓ, reservoir catalyst material, a conventional NH₃—SCR catalyst material, and/or some other material for reducing nitrogen oxide emissions.

28. The exhaust gas system according to claim 26, wherein the catalyst material includes a conventional NOₓ, reservoir catalyst material, a conventional NH₃—SCR catalyst material, and/or some other material for reducing nitrogen oxide emissions.

29. The exhaust gas system according to claim 22, wherein the surface filter comprises a cordierite filter having a cell number of from approximately 50 to approximately 300 cpsi, a porosity of approximately 50%, and a pore diameter of no larger than approximately 100 μm, preferably no larger than approximately 40 μm, even more preferably no larger than approximately 10 μm.

30. The exhaust gas system according to claim 22, wherein the surface filter includes a Pt catalyst material, in particular Pt—CE/ZrO₂, on its inflow side and a conventional NOₓ reservoir catalyst material on its outflow side.

31. A method for operating an internal combustion engine having an exhaust gas system according to claim 18, including continuously oxidizing soot deposited in the surface filter.
